(19) United States
(12) Patent Application Publication
(10) Pub. No.: US 2013/0120119 A1
(43) Pub. Date: May 16, 2013

(54) ADAPTING RADIO FREQUENCY IDENTIFICATION REQADER POWER LEVELS

(71) Applicant: Russell E. Calvarese, Stony Brook, NY (US)

(72) Inventor: Russell E. Calvarese, Stony Brook, NY (US)

(73) Assignee: SYMBOL TECHNOLOGIES, INC., HOLTSVILLE, NY (US)

(21) Appl. No.: 13/298,026

(22) Filed: Nov. 16, 2011

(51) Int. Cl. G06K 7/01

(52) U.S. Cl. 340/10.5

(57) ABSTRACT

A system and method for adapting a radio frequency identification (RFID) reader power level includes a step of determining (300) if a first RFID reader can read an RFID tag. A next step includes determining (302) if a second RFID reader can read that same RFID tag. A next step includes reducing (306) a power level of one of the RFID readers such that it can no longer read the RFID tag.

### FIELD OF THE DISCLOSURE

The present invention relates generally to radio frequency identification (RFID) readers and more particularly to adapting the power levels of such RFID readers.

### BACKGROUND

At present, inventory systems have been introduce to track items that include small, electronic identification tags. Such radio frequency identification (RFID) tags are not self-powered typically, but are powered and triggered to respond with their stored identification information upon being scanned by a local RFID reader. Typically, RFID scanners can read the tags on tagged items using a hand-held, battery-powered RFID reader or through the use of an automated RFID scanning device. These scanners can be triggered manually, by a user, or can be triggered automatically using sensors that detect the presence of an item in proximity to the RFID scanner.

In practice, RFID readers have a limited range, and it is necessary to deploy many such readers in the hope of capturing all RFID tags within an inventory area. However, it can be a common occurrence for neighboring RFID scanners to read the same RFID tag, which wastes resources and requires an intelligent system to address redundant readings of the same tag. In addition, AND RFID reader can possibly generate local RF spectrum interference for, or collisions with, nearby RFID scanners or other readers.

Accordingly, there is a need to reduce power levels between neighboring RFID scanners such that all tags can be read while limiting collisions and reducing read overlap. It would also be of benefit to limit battery drain of an RFID reader.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a block diagram of a RFID reader, in accordance with the present invention.

FIG. 2 is a block diagram of a system incorporating the RFID reader of FIG. 1, in accordance with the present invention.

FIG. 3 is a flowchart of a method, in accordance with the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

The present invention provides a system and method to reduce power levels between neighboring radio frequency identification (RFID) readers such that all tags within an inventory area can be read while limiting collisions and reducing the number of RFID tags being read by readers with overlapping read ranges. The present invention also limits the battery drain of an RFID reader.

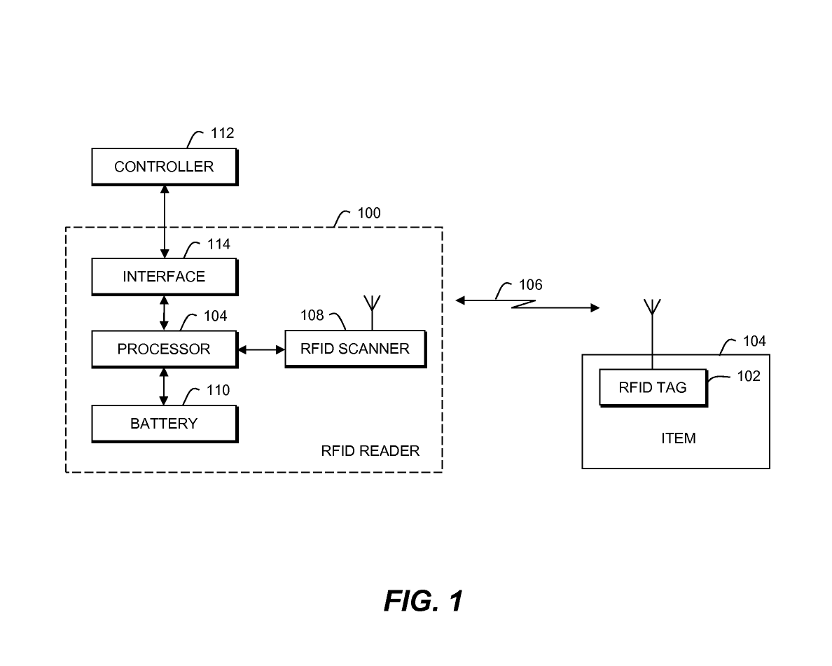

FIG. 1 is a block diagram depiction of a wireless RFID reader system for performing an RFID scan 106 of an RFID tag, in accordance with the present invention. The system comprises and RFID reader 100 and an RFID tag 102 affixed to an item 104 to be inventoried. The RFID reader includes a processor 104 for controlling the functions of the reader. The processor is coupled to a power source 106, such as a battery, and an interface 114 for communicating with an external backend controller 112 of the system. The processor is also coupled to an RFID scanner 108 that includes a power amplifier. In operation, the processor 104 controls the RFID scanner to capture and read an RFID tag 102 of an item 104 to be scanned and inventoried. In accordance with the present invention, the processor is able to control a power level of the power amplifier of the scanner in response to instructions from the controller, as will be detailed below.

The system described herein uses a wireless RFID air interface 106 for communication with electronic RFID tags 102 that may be affixed to, or embedded within, various different physical items 104, as is known in the art, and is used in the implementation of various embodiments of the present invention. RFID scanners and RFID tags are known to refer to a wide variety of business electronic platforms and can include other devices and functions, as are known in the art and therefore not shown for the sake of simplicity.

In general, components such as processors, communication interfaces, RFID scanners, power supplies, power amplifiers, and RFID tags are well-known, and will not be described in detail herein for the sake of brevity. It should be recognized that processing units are known to comprise basic components such as, but not limited to, microprocessors, microcontrollers, memory, application-specific integrated circuits, and/or logic circuitry. Such components are typically adapted to implement algorithms and/or protocols that have been expressed using high-level design languages or descriptions, expressed using computer instructions, or expressed using messaging logic flow diagrams.

Thus, given an algorithm, a logic flow, a messaging/signaling flow, and/or a protocol specification, those skilled in the art are aware of the many design and development techniques available to implement a processor that performs the given logic. Therefore, the elements shown each represent a known apparatus that has been adapted, in accordance with the description herein, to implement various embodiments of the present invention. Furthermore, those skilled in the art will recognize that aspects of the present invention may be implemented in and across various physical components and none are necessarily limited to single platform implementations. For example, the elements of the present invention described above may be implemented in any one or more devices. It is within the contemplation of the invention that the operating requirements of the present invention can be implemented in software, firmware or hardware, with the function being implemented in a software processor (or a digital signal processor) being merely an option.

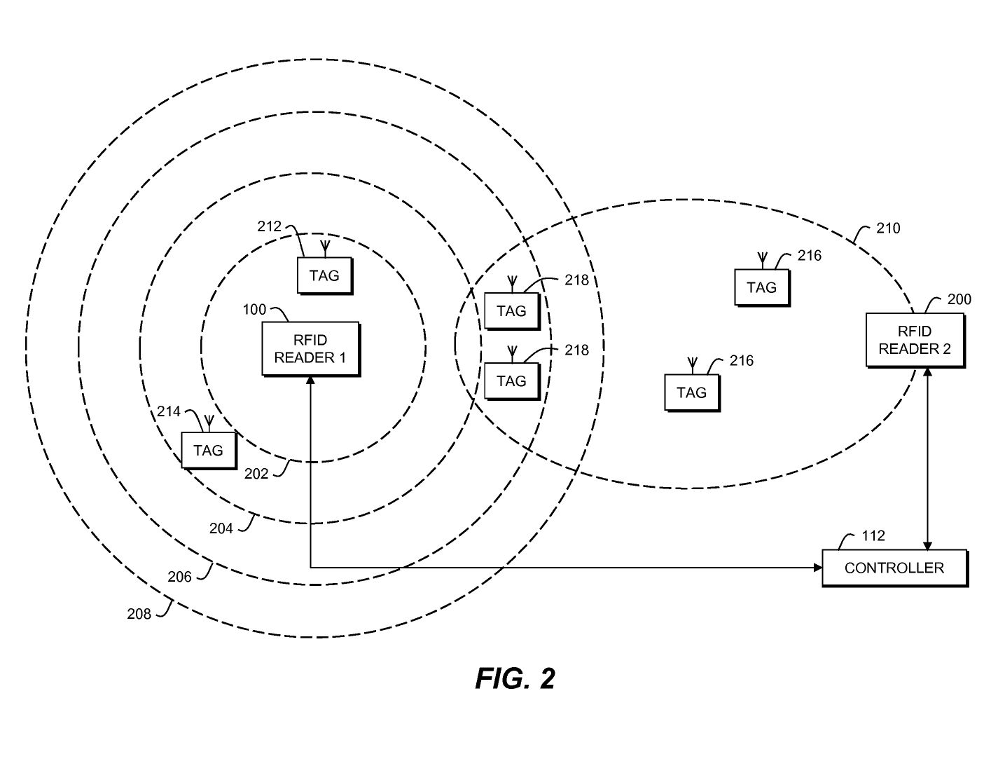

FIG. 2 shows a system incorporating the RFID reader 100 of the present invention. Upon a successful scanning of an RFID tag, the reader 100 will relate information to the backend controller 112 so that the controller can determine that the reader was able to read the tag. For example, if the scanning was successful, the processor of the reader 100 will supply an identifier of the tag (and its associated item) to the controller 112. In this case, the controller can automatically register the item in its database. In accordance with the present invention, the processor of the RFID reader can also supply the controller with information regarding its operating power level and power source (e.g. AC mains voltage, battery supply, battery charge remaining, etc.), which the controller can use to direct power levels of various readers under its control. The processor can also supply the controller with information about a reader's antenna directivity ability, such as beam steering or antenna switching ability, if any. It is envisioned that an RFID reader can have multiple switched antennas with serves the same function as beam steering in the context of this application.

The RFID reader is able to change the power level of its RFID scanner power amplifier to effect different RFID scanning ranges 202-208. For example, at a lowest power level, the range 202 of the scanner will only be able to read nearby RFID tags 212. At a higher power level, the range 214 of the scanner may be able to capture more RFID tags 214 in its vicinity. At an even higher power level, the range 206 of the scanner can capture even more RFID tags 216. At a maximum power level, the range 208 may not be able to capture any more RFID tags. In this event, and in order to save power drain on the reader, the controller can direct the reader to reduce its power level and set a maximum power level at range 206. In particular, the controller can establish a threshold power level for each RFID reader where increasing the power level above the threshold power level no longer captures any more RFID tags.

The controller 112 is also able to control other readers in its system, such as a second RFID reader 200. In the example show, the second reader 200 has a directable antenna coverage, such as steerable beam or switchable antenna(s), and is able to capture tags in its range 210 including nearby tags 216 and farther tags 218. Since both readers 100, 200 are under control of the controller, the controller is able to note that both readers are able to read the same tags 218. In other words, there is overlap of RFID range coverage. In accordance with the present invention, the controller is able to direct one of the readers, in this example the first reader 100, to reduce its power level so there is no overlap of tag readings, i.e. the first reader can no longer read that tag. In this example, unless there are any non-overlapping tags that can only be read by the first RFID reader at its present power level, the first reader 100 is directed to lower its power level even farther, to range 204, such that both readers can now read and inventory all tags 212-218 mutually exclusively. If the controller has information regarding the power sources of each reader (e.g. AC mains voltage, battery supply, battery charge remaining, etc.), the controller can direct the reader with the most depleted power source to reduce its power level. In addition, if the controller has information about antenna directivity ability, such as beam steering or antenna switching ability of particular readers, the controller can direct a reader's beam steering or antenna switching to read a particular tag. In this way, all tags are still able to be read and inventoried in the system, and power is not wasted in the system.

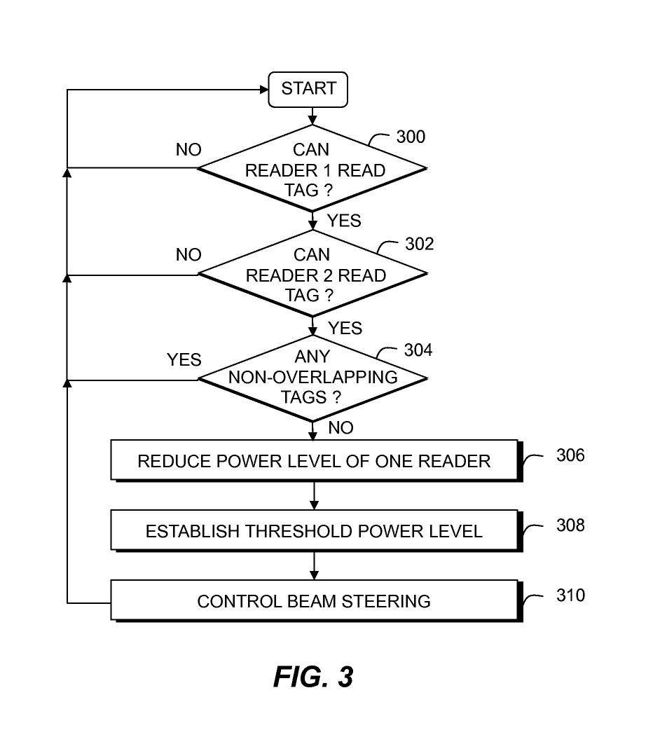

FIG. 3 illustrates a flowchart of a method for adapting a radio frequency identification (RFID) reader power level, in accordance with the present invention. The method starts by determining 300 if a first RFID reader can read an RFID tag at a given power level.

A next step determines 302 if any other (second) RFID reader can read that same RFID tag.

A next step determines 304 that there are no non-overlapping tags that can only be read by one reader at its present power level.

If more than one reader can read the same tag, a next step reduces 306 a power level of one of the RFID readers such that it can no longer read the RFID tag unless there are any non-overlapping tags that can only be read by that one reader at its present power level. Otherwise, the other reader is directed to reduce its power level unless it too has a non-overlapping tag that can only be read by that other reader at its present power level. In one embodiment, this step includes reducing the power level of the RFID reader having the most depleted power source, e.g. its battery.

An optional step is establishing 308 a threshold power level for each RFID reader where increasing the power level no longer captures any more RFID tags.

Another optional step is controlling 310 an antenna directivity of the second RFID reader to read a particular RFID tag.

Advantageously, the present invention can increase the battery life of RFID readers and can reduce collisions between neighboring RFID readers, thereby increasing system performance. In addition, the present invention will reduce the amount of overlapping reads of the same tags, which wastes resources.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits, in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A method for adapting a radio frequency identification (RFID) reader power level, the method comprising:
determining (300) if a first RFID reader can read an RFID tag;
determining (302) if a second RFID reader can read that same RFID tag; and
reducing (306) a power level of one of the RFID readers such that it can no longer read the RFID tag.

2. The method of claim 1, further comprising determining (304) that there are no non-overlapping tags that can only be read by one reader at its present power level.

3. The method of claim 1, further comprising establishing (308) a threshold power level for each RFID reader where increasing the power level above the threshold power level no longer captures any more RFID tags.

4. The method of claim 1, wherein reducing (306) include reducing the power level of the RFID reader having the most depleted power source.

5. The method of claim 4, wherein at least one of the RFID readers is battery powered.

6. The method of claim 1, further comprising controlling (310) an antenna directivity of the second RFID reader to read a particular RFID tag.

7. A system for adapting a radio frequency identification (RFID) reader power level, the system comprising:
at least one RFID reader (100) having an adjustable power level for its RFID scanner (108); and
a controller (112) coupled to the at least one RFID reader, the controller operable to control the power levels of the at least one RFID reader, the controller also operable to determine if a first RFID reader can read an RFID tag (102) and if a second RFID reader (200) can read that same RFID tag (102), wherein the controller directs one of the RFID readers to reduce its power level such that it can no longer read the RFID tag.

8. The system of claim 7, wherein the controller if further operable to determine that there are no non-overlapping tags that can only be read by one reader at its present power level.

9. The system of claim 7, wherein the controller is further operable to establish a threshold power level for each RFID reader where increasing the power level above the threshold power level no longer captures any more RFID tags.

10. The system of claim 7, wherein the controller can reduce the power level of the RFID reader having the most depleted power source.

11. The system of claim 10, wherein at least one of the RFID readers is battery powered.

12. The system of claim 7, wherein the controller is operable to control an antenna directivity of a second RFID reader to read a particular RFID tag.

13. A radio frequency identification (RFID) reader with an adaptable power level, the RFID reader comprising:
an RFID scanner (108) with a power amplifier having an adjustable power level;
an interface (114) operable to communicate with a controller (112); and
a processor (104) coupled to the interface and the RFID scanner, the processor operable receive power level instructions from the controller and operable to adjust the power level of the power amplifier in response to the a determination that a second RFID reader (200) can read that same RFID tag (218), whereupon the processor controls the power level such that the RFID reader can no longer read the RFID tag (218).

14. The RFID reader of claim 13, wherein the determination determines that that there are no non-overlapping tags that can only be read by one reader at its present power level.

15. The RFID reader of claim 13, wherein the processor can establish a threshold power level (206) for the power amplifier where increasing the power level above (208) the threshold power level no longer captures any more RFID tags.

16. The RFID reader of claim 13, further comprising a battery (110), wherein the battery is more depleted than the power source of the second RFID reader (200).

17. The RFID reader of claim 13, wherein the determination determines that a n antenna directivity of the second RFID reader can be controlled to read a particular RFID tag.
